(19) United States
(12) Patent Application Publication
(10) Pub. No.: US 2025/0200288 A1
(43) Pub. Date: Jun. 19, 2025

(54) METHOD AND APPARATUS FOR GENERATING MULTI-INTENT UTTERANCE DATASETS

(71) Applicants: HYUNDAI MOTOR COMPANY, Seoul (KR); KIA CORPORATION, Seoul (KR); IUCF-HYU (INDUSTRY-UNIVERSITY COOPERATION FOUNDATION HANYANG UNIVERSITY), Seoul (KR)

(72) Inventors: Chan Hee Park, Hwaseong-si (KR); Tae Uk Kim, Seoul (KR); Jung Yeon Lee, Seoul (KR); Ye Jin Yoon, Seoul (KR); Kang San Kim, Seoul (KR)

(73) Assignees: HYUNDAI MOTOR COMPANY, Seoul (KR); KIA CORPORATION, Seoul (KR); IUCF-HYU (INDUSTRY-UNIVERSITY COOPERATION FOUNDATION HANYANG UNIVERSITY), Seoul (KR)

(21) Appl. No.: 18/972,132

(22) Filed: Dec. 6, 2024

(30) Foreign Application Priority Data
Dec. 14, 2023 (KR) 10-2023-0181999
Jun. 3, 2024 (KR) 10-2024-0072241

(51) Int. Cl. G06F 40/30

(52) U.S. Cl. CPC G06F 40/30

(57) ABSTRACT

A computable-implementable method for generating multi-intent datasets includes collecting single-intent datasets; preprocessing the collected single-intent datasets while preserving meanings and structures of utterances in the collected single-intent datasets; selecting a plurality of single-intent utterances to be merged from the preprocessed single-intent datasets; and merging the plurality of selected single-intent utterances into one multi-intent utterance.

### CROSS-REFERENCE TO RELATED APPLICATION

This application claims priority to Patent Application No. 10-2023-0181999, filed in the Korean Intellectual Property Office on Dec. 14, 2023, and Patent Application No. 10-2024-0072241, filed in the Korean Intellectual Property Office on Jun. 3, 2024, the entire contents of each of which are incorporated herein by reference.

### TECHNICAL FIELD

The present disclosure relates to a method and an apparatus for generating multi-intent utterance datasets.

### BACKGROUND

The following description merely provides background information related to the present embodiment and does not constitute the related art.

A task-oriented dialogue system (TOD) is an artificial intelligence system that grasps specific goals or needs by analyzing user's utterances and generates responses to the specific goals or needs. The task-oriented dialogue system can be used in various situations such as online shopping, booking systems, customer services, etc. The task-oriented dialog system requires the capability to accurately understand the user's needs and efficiently deal with the user's needs.

An “intent” refers to the purpose or goal a user intends to achieve by interacting with a dialogue system, for example, a chatbot. For example, the intent may be the underlying meaning or needs behind a question asked by a user. A multi-intent utterance is an expression of two or more different needs or intents a user makes in a single utterance. An example of such utterances is a sentence like “Book a flight for tomorrow morning and recommend a hotel nearby”. The user often speaks with multiple purposes. However, task-oriented dialogue systems are traditionally more inclined to interpret a user's utterance as being related to a single purpose.

According to a study published in 2019, over half of the TOD datasets created by Amazon®, a company engaged in e-commerce and artificial intelligence, were reported as being multi-intent utterances. In designing and developing task-oriented dialogue systems, it is becoming increasingly important to grasp users' various intents and needs.

Despite the great interest in multi-intent utterances, resources supporting this research are quite limited. MixATIS and MixSNIPS, which are multi-intent utterance datasets that are currently being used widely, are generated by merging two or more single-intent utterances. MixATIS and MixSNIPS always include one of ‘and’, ‘and then’, and ‘and also’ to merge single-intent utterances. However, MixATIS and MixSNIPS faced criticism for the insufficient diversity in the connectives used to generate datasets. MixATIS and MixSNIPS exploit naïve merging patterns since they only use AND variants. The naïve patterns allow a multi-intent detection model to learn to identify the number of intents too easily. For example, the multi-intent detection model may easily identify the number of intents in an utterance by either counting the occurrences of the conjunction ‘and’ or recognizing the presence of a ‘,(comma)’. The existing studies have not paid enough attention to this problem but have relied merely on datasets.

### SUMMARY

A primary aspect of the present disclosure aims to provide a method and an apparatus for generating datasets featuring more complex and varied intents than existing multi-intent datasets, by concatenating utterances using various conjunctions and complex patterns.

The aspects of the present disclosure are not limited to the foregoing, and other aspects not mentioned herein should be able to be clearly understood by those having ordinary skill in the art from the following description.

According to an aspect of the present disclosure, a computable-implementable method for generating multi-intent datasets includes collecting single-intent datasets. The method also includes preprocessing the collected single-intent datasets while preserving meanings and structures of utterances in the collected single-intent datasets. The method also includes selecting a plurality of single-intent utterances to be merged from the preprocessed single-intent datasets. The method also includes merging the plurality of selected single-intent utterances into one multi-intent utterance.

According to another aspect of the present disclosure, an apparatus for generating multi-intent datasets includes a memory configured to store one or more instructions and at least one processor configured to execute the one or more instructions stored in the memory. The at least one processor, by executing the one or more instructions, is configured to collect single-intent datasets. The at least one processor is also configured to preprocess the collected single-intent datasets while preserving the meanings and structures of utterances in the collected single-intent datasets. The at least one processor is also configured to select a plurality of single-intent utterances to be merged from the preprocessed single-intent datasets. The at least one processor is also configured to merge the plurality of selected single-intent utterances into one multi-intent utterance.

According to an embodiment of the present disclosure, multi-intent datasets can be generated using complex patterns and various conjunctions. Accordingly, it is possible to obtain multi-intent datasets using varied connectives, without resorting to simple concatenation rules used in MixATIS and MixSNIPS.

According to an embodiment of the present disclosure, multi-intent datasets may be generated to reflect various situations or contexts. Accordingly, the diversity and complexity of real-world conversations between people can be reflected in multi-intent datasets. Moreover, the use of generated multi-intent datasets allows a task-oriented dialogue system to grasp and understand multiple intents more accurately from user's utterances.

The effects of the present disclosure are not limited to the foregoing, and other effects not mentioned herein should be able to be clearly understood by those having ordinary skill in the art from the following description.

### BRIEF DESCRIPTION OF THE DRAWINGS

FIG. 1 is a block diagram schematically showing an apparatus for generating multi-intent datasets according to an embodiment of the present disclosure.

FIG. 2 is a view illustrating a process for generating a multi-intent dataset by merging single-intent datasets.

FIG. 3 is a flowchart showing a method for generating multi-intent datasets according to an embodiment of the present disclosure.

FIG. 4 is a block diagram schematically illustrating a computing device that can be used to implement the method or the apparatus according to the present disclosure.

### DETAILED DESCRIPTION

Hereinafter, some embodiments of the present disclosure should be described in detail with reference to the accompanying drawings. In the following description, like reference numerals designate identical or like elements, although the elements are shown in different drawings. Further, in the following description of some embodiments, a detailed description of known functions and configurations incorporated therein has been omitted for the purpose of clarity and for brevity.

Additionally, various terms, such as first, second, A, B, (a), (b), etc., are used solely to differentiate one component from the other and are not intended to imply or suggest the substances, order, or sequence of the components. Throughout the present disclosure, when a part ‘includes’ or ‘comprises’ a component, the part is meant to further include other components and not to exclude other components unless specifically stated to the contrary. The terms, such as ‘unit’, ‘module’, and the like, refer to one or more units for processing at least one function or operation, which may be implemented by hardware, software, or a combination thereof.

The following detailed description, together with the accompanying drawings, is intended to describe embodiments of the present disclosure and is not intended to represent the only embodiments in which the present disclosure may be practiced.

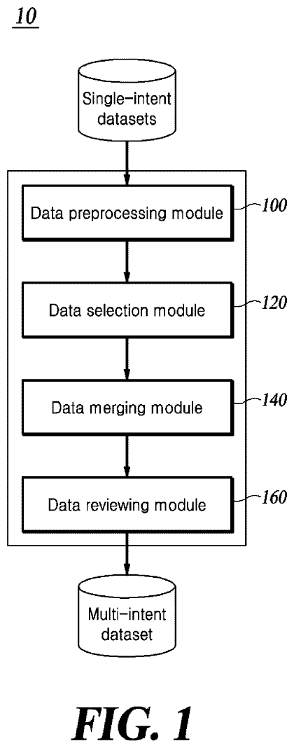

FIG. 1 is a block diagram schematically showing an apparatus for generating multi-intent datasets according to an embodiment of the present disclosure.

An apparatus for generating multi-intent datasets 10 according to an embodiment of the present disclosure may include all or some of a data preprocessing module 100, a data selection module 120, a data merging module 140, or a data reviewing module 160. It should be noted that not all of the blocks shown in FIG. 1 are essential components, and, in other embodiments, some blocks included may be added, altered, or removed. Meanwhile, the components shown in FIG. 1 show functionally distinct elements, and at least one component may be implemented in such a manner as to be integrated together in an actual physical environment.

The data preprocessing module 100 preprocesses data for merging single-intent utterances while preserving their original meanings or structures. The data selection module 120 selects utterances to be merged from the single-intent datasets. The data merging module 140 generates a multi-intent dataset by merging the selected utterances. The data reviewing module 160 reviews the generated multi-intent dataset by using a generative model.

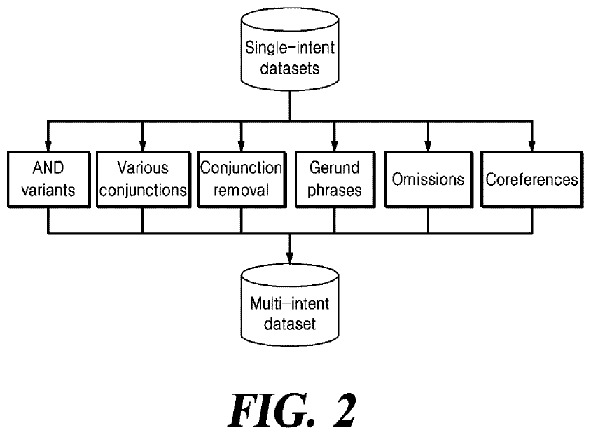

FIG. 2 is a view illustrating a process for generating a multi-intent dataset by merging single-intent datasets.

Methods for merging single-intent datasets include “Explicit concatenation” and “Implicit concatenation”. Explicit concatenation is a merging method in which connectives are explicitly used to concatenate utterances. Explicit concatenation includes an “AND variants method” and a “various conjunctions method”.

The AND variants method is a method in which two or more single-intent utterances are merged by using one or more of ‘and’, ‘and then’, ‘and also’, or ‘,(comma)’. It is the same method as the method of generating MiXATIS and MixSNIPS, which are multi-intent datasets that are currently being used widely.

The various conjunctions method is a method in which two or more single-intent utterances are merged by using one or more of ‘and’, ‘and then’, ‘and also’, ‘,(comma)’, ‘;(semi-colon)’, ‘or’, ‘before’, ‘after’, ‘additionally’, ‘finally’. It is possible to merge single-intent utterances by using various conjunctions, without relying solely on the AND variants method.

Implicit concatenation is a merging method in which explicit connectives are not used to concatenate utterances. Implicit concatenation includes a “conjunction removal method”, a “gerund phrases method”, an “omissions method”, and a “coreferences method”.

The conjunction removal method is a method in which single-intent utterances are merged by removing a conjunction. By this method, single-intent utterances can be merged easily and simply. The conjunction removal method effectively reflects the intuition that speakers tend to favor shorter utterances.

The gerund phrase method is a method in which sentences are merged by transforming a particular utterance into a gerund phrase (the -ing form of verbs). It emphasizes the concurrency of multiple sentences and allows the merging of single-intent utterances. The gerund phrase method is applicable to utterances that satisfies a particular condition. The utterances that satisfy a particular condition may be sentences that start with a verb or some interrogative sentences that can be converted naturally into a participial construction.

The omissions method is a method in which single-intent utterances are merged by arbitrarily eliminating redundant expressions in multiple sentences.

The coreferences method is a method in which single-intent utterances are merged by eliminating redundant expressions in multiple sentences or substituting the redundant expressions with pronouns.

Table 1 shows concatenation results of two single-intent utterances by various merging methods.

TABLE 1

| Categories | Utterances |
|---|---|
| Single-intent utterance 1 (Intent 1) | play my 88 keys playlists (PlayMusic) |
| Single-intent utterance 2 (Intent 2) | add another song to my 88 keys playlist (AddToPlaylist) |

| Concatenation methods | | Concatenation results |
|---|---|---|
| Explicit concatenation | | play my 88 keys playlist and also add another song to my |
| | | 88 keys playlist |
| Implicit concatenation | Gerund phrases | add another song to my 88 keys playlist playing |
| | Conjunction removal | play my 88 keys playlist add another song to my 88 keys |
| | Omissions | playlist |
| | Coreferences | play my 88 keys playlist and add another song |
| | | play my 88 keys playlist and add another song to it |

Single-intent utterance 1 is ‘play my 88 keys playlist’ and the intent of single-intent utterance 1 is ‘PlayMusic’. Single-intent utterance 2 is ‘add another song to my 88 keys playlist’, and the intent of single-intent utterance 2 is ‘AddToPlaylist’.

‘play my 88 keys playlist and also add another song to my 88 keys playlist’ may be formed by merging single-intent utterance 1 and single-intent utterance 2 by using the AND variants method. The single-intent utterances were merged by adding ‘and also’ between the sentences.

‘add another song to my 88 keys playlist playing’ may be formed by merging single-intent utterance 1 and single-intent utterance 2 by using the gerund phrases method.

‘play my 88 keys playlist add another song to my 88 keys playlist’ may be formed by merging single-intent utterance 1 and single-intent utterance 2 by using the conjunction removal method.

‘play my 88 keys playlist and add another song’ may be formed by merging single-intent utterance 1 and single-intent utterance 2 by using the omissions method.

‘play my 88 keys playlist and add another song to it’ may be formed by merging single-intent utterance 1 and single-intent utterance 2 by using the coreferences method. Single-intent utterance 1 and single-intent utterance 2 were merged by eliminating the redundant expression ‘my 88 keys playlist’ and substituting it with a pronoun ‘it’.

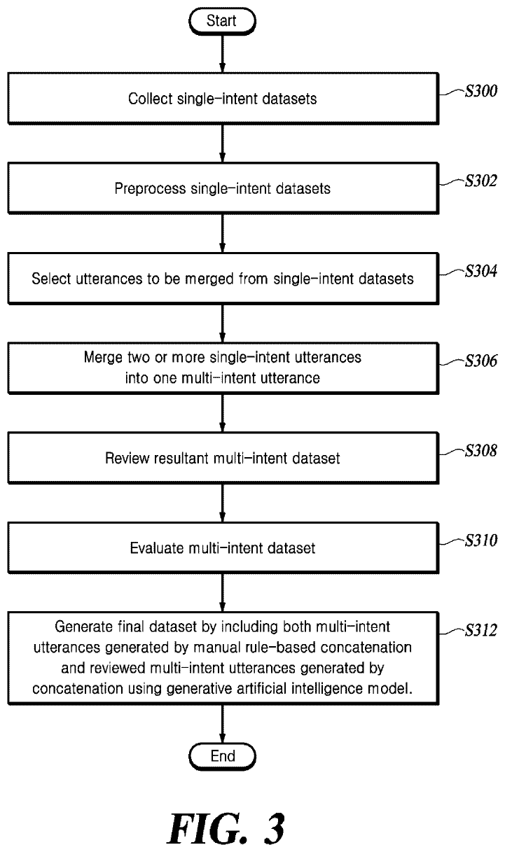

FIG. 3 is a flowchart showing a method for generating multi-intent datasets according to an embodiment of the present disclosure.

In step S300, the apparatus for generating multi-intent datasets 10 collects single-intent datasets that are used to be merged into a multi-intent dataset. Although single-intent datasets used in one embodiment of the present disclosure are in English, the datasets are not limited to this. An intent needs be explicitly defined within a single-intent dataset.

In the embodiment of the present disclosure, single-intent datasets ATIS, SNIPS, Banking77, and CLINC150 are used. ATIS (Airline Travel Information System) is a natural language processing dataset that focuses on airline travel information. SNIPS is a speech recognition training dataset that encompasses various domains (weather, music, etc.). Banking77 is a dataset that focuses on banking-related queries. CLINC150 is a dataset that deals with domains, such as banking, travel, restaurants, etc. ATIS, SNIPS, Banking77, and CLINC150 can be used for data merging.

In step S302, the apparatus for generating multi-intent datasets 10 preprocesses single-intent datasets. In the preprocessing step, the original meanings and structures of utterances in the single-intent datasets need to be preserved. For example, in the preprocessing process, capital letters in datasets are converted into lower-case letters. Then, punctuation marks ‘.’, ‘?’, ‘!’ are removed.

In step S304, the apparatus for generating multi-intent datasets 10 selects single-intent utterances to be merged. Methods for selecting utterances to be merged from single-intent datasets include “randomized selection” and “selection based on cosine similarity”. Randomized selection is a method for randomly selecting utterances with different intents. Because the utterances are randomly selected, the selected utterances may not be similar in words or structure. Thus, with randomized selection, it might be difficult to perform the omissions method and the coreferences method, which are implicit concatenation methods.

Selection based on cosine similarity is a method for computing the cosine similarity between utterances and selecting utterances of a certain value or higher. Cosine similarity is a method for measuring similarity between two vectors by computing the angle between the two vectors. The cosine value is calculated by using the dot product of the two vectors and the magnitudes of the vectors. The closer the cosine value to 1, the more similar the two vectors are in direction. Cosine similarity is a measure of how similar given words are in structure or format. The closer the cosine similarity between words is to 1, the more similar the words are in structure or format. Cosine similarity can be applied after text is converted into vectors.

Redundant expressions in sentences are required in order to employ the omissions method or the coreferences method. Thus, in the present disclosure, utterances are selected based on cosine similarity in order to employ the omissions method or the coreferences method.

In the present disclosure, two or more utterances having a cosine similarity of a certain value or higher are selected. For example, in the present disclosure, utterances having a cosine similarity of 0.7 or higher are essentially selected. As another example, in the present disclosure, utterances having a minimum cosine similarity of 0.5 are selected depending on the dataset. In the present disclosure, the certain value is not fixed, and the present disclosure is not limited to the above examples.

When choosing three utterances, cosine similarity is measured for every case of two utterances, and utterances are selected when the utterances all have a cosine similarity of a certain value or higher. Using selection based on cosine similarity, utterances having a similar structure or containing redundant words may be retrieved, and implicit concatenation may become easier than when randomly selecting utterances.

In step S306, the apparatus for generating multi-intent datasets 10 generates one multi-intent utterance by merging two or more single-intent utterances. The merging method includes “manual rule-based concatenation” and “concatenation using a generative artificial intelligence model”. Manual rule-based concatenation is a method for merging single-intent utterances based on various manually-defined rules. Manual rule-based concatenation includes the AND variants method, the various conjunctions method, the conjunction removal method, and the gerund phrases method. Concatenation using a generative artificial intelligence model is a method of merging two or more single-intent utterances by using a pre-trained generative artificial intelligence language model. Concatenation using a generative artificial intelligence model includes the AND variants method, the various conjunctions method, the conjunction removal method, the gerund phrases method, the omissions method, and the coreferences method. In the present disclosure, a state-of-the art generative artificial intelligence model capable of both explicit concatenation and implicit concatenation are used to generate complex multi-intent datasets. For example, ChatGPT may be used and show high performance in various natural language processing tasks, such as summarization, provision of intelligence, and translation.

Depending on the utterance selection method, a multi-intent dataset may be generated from randomly selected utterances by using a manual rule-based concatenation, and a multi-intent dataset may be generated from utterances selected based on cosine similarity by using a concatenation method using a generative artificial intelligence model. Pre-selected two or more utterances and an enhanced prompt are fed into a generative artificial intelligence model to perform explicit concatenation or implicit concatenation and generate a multi-intent dataset.

An example of a prompt fed to a generative artificial intelligence model in the present disclosure is as depicted in Table 2.

TABLE 2
You are a native English speaker.
[Task Definition] Combine 2 or 3 utterances as one single utterance.
[Goal] The focus is on creating a single utterance that captures the essence of both ideas without
unnecessary redundancy.
[Instructions]
Avoid adding just punctuation.
Don't paraphrase.
Don't compromise the meaning of each utterance.
Don't replace numbers with radix.
Maintain the intent of each utterance.
Don't forget that if a utterance starts with a verb, it's a statement.
Do NOT use conjunctions like [symbol] and [symbol]
Don't print intent directly. [symbol]
iterations
[Example 1]
play my 88 keys playlist (PlayMusic) [symbol] add another song to my 88 keys playlist (AddInPlaylist)
[Good Answer] while playing my 88 keys playlist, add another song to it.
[Bad Answer] Play my 88 keys playlist and also add another song to my 88 keys playlist.
. . .
[Query] Combine the following utterances naturally.
Inside the parentheses is the intent of each utterance: [symbol] (intent [symbol] ) + [symbol] (intent [symbol] ) [symbol]
indicates data missing or illegible when filed

The format of a prompt fed to a generative artificial intelligence model is not limited to specific formats or to the format shown in Table 1. For example, a prompt with instructions added to or removed from it may be fed. As another example, a prompt in which an example is added, removed, or modified may be fed.

Step S308 is a step of reviewing a multi-intent dataset generated by a generative artificial intelligence model.

The generative artificial intelligence model does not always guarantee a correct answer. Even if an example and instructions are clearly suggested, the model may generate an unwanted result. For example, when generating a multi-intent utterance by merging single-intent utterances, the generative artificial intelligence model may distort intentions or even partially remove intentions. Moreover, it may fail to merge and therefore generate an incorrect sentence. This may make the user doubt the credibility of results from the generative artificial intelligence model. Thus, the step of reviewing a multi-intent dataset generated by a generative artificial intelligence model is needed.

Evaluation measures used to determine whether the generative artificial intelligence model properly performs explicit concatenation include a word frequency metric, a linking word frequency metric, and a pronoun frequency metric. The evaluation measures provide insight into estimating the degree of linguistic transformations resulting from concatenation. All metrics have a value of 0 or 1.

Mathematical Formula 1 is a formula that represents a word frequency metric.

$$W ( utt , n ) = {1}_{Z - N} ( {\vert utt \vert}_{word} - {\sum }_{i = 1}^{n} {\vert {utt}_{i} \vert}_{word} ) \qquad Mathematical Formula 1$$

Let the metric be 1 if the number of words in an utterance after concatenation is less than or equal to the total number of words in utterances before concatenation; otherwise 0. A metric value of 1 may indicate that the omissions method or the coreferences method, among the explicit concatenation methods, was used, or that no words were added in the concatenation process.

Mathematical Formula 2 is a format that represents a linking word frequency metric.

$$C ( utt , n ) = {1}_{Z - N} ( {\vert utt \vert}_{conj} - {\sum }_{i = 1}^{n} {\vert {utt}_{i} \vert}_{conj} ) \qquad Mathematical Formula 2$$

Let the metric be 1 if the number of linking words in an utterance after concatenation is less than or equal to the total number of linking words in utterances before concatenation; otherwise 0. A metric value of 1 may indicate that no explicit linking words were used when merging utterances.

Mathematical Formula 3 is a format that represents a pronoun frequency metric.

$$P ( utt , n ) = {1}_{N} ( {\vert utt \vert}_{pron} - {\sum }_{i = 1}^{n} {\vert {utt}_{i} \vert}_{pron} ) \qquad Mathematical Formula 3$$

Let the metric be 1 if the number of pronouns in an utterance after concatenation is greater than the total number of pronouns in utterances before concatenation; otherwise 0. A metric value of 1 may indicate that redundant expressions were substituted with pronouns when merging two or more utterances.

Therefore, it may be assumed that, if the metric is 1, an utterance has been generated as the user intends it to be. However, there may be a case where there is a significant discrepancy before and after concatenation. For example, if the number of linking words in original utterances has increased from 2 to 6 after concatenation, it may indicate unnecessary paraphrases different from the original utterances, while a significant decrease may suggest overlooked utterances during concatenation, failing to preserve the original intents of the utterances. In this case, the concatenation is deemed unsuccessful, and the concatenation result may be excluded from a final dataset.

In Step 308, there are three stages of reviewing. First, only sentences with a metric value of 1 are selected. If the number of words in an utterance after concatenation is less than or equal to the total number of words in utterances before concatenation, the word frequency metric has a value of 1. If the number of linking words in an utterance after concatenation is less than or equal to the total number of linking words in utterances before concatenation, the linking word frequency metric has a value of 1. If the number of pronouns in an utterance after concatenation is greater than the total number of pronouns in utterances before concatenation, the pronoun frequency metric has a value of 1. In the next step, a TFMN, which has cutting-edge capabilities in terms of multi-intent detection, is used to sort out sentences that features failed intent detection. Lastly, experts with an understanding of artificial intelligence will review the results and remove sentences whose intents are damaged.

In step S310, an evaluation is conducted of how well multi-intent datasets are generated using an artificial intelligence model and generated datasets. The model is trained on datasets that are generated in a conventional method, and the evaluation is made using multi-intent datasets generated according to the present disclosure. The datasets generated in a conventional method refer to MixSNIPS and MixATIS. A dataset generated by the method of creating MixSNIPS and MixATIS may include MixBanking77 and MixCLINC150. Datasets generated by the dataset generation methods of the present disclosure may include BlendSNIPS, BlendATIS, BlendBanking77, and BlendCLINC150.

Models used in supervised learning are TFMN and SLIM. The TFMN model predicts the number of intents in a multi-intent utterance. Subsequently, the TFMN model yields the most probable intent. The SLIM model selects an intent if the output a neural network produces for that intent exceeds a set threshold. The neural network predicts the probability of each intent, and this predicted probability is then passed out through an activation function. Afterwards, if the probability of the intent is greater than or equal to a set threshold, that intent is deemed as present and produced as a final result. The set threshold may be 0.5, for example.

In unsupervised learning, evaluations were performed by ChatGPT.

Accuracy was used to evaluate multi-intent detection performance. Table 3 shows evaluation results.

TABLE 3

| | | | Source datasets (single-intent utterance datasets used | | | |
|---|---|---|---|---|---|---|
| | Training-evaluation data combinations | | to be merged into multi-intent utterance) | | | |
| Model | Training data | Evacuation data | SNIPS | ATIS | Banking77 | CLINC150 |
| TFMN | Datasets generated in | Datasets generated | 95.96 | 76.80 | 76.11 | 85.60 |
| | conventional method | according to present | | | | |
| | | disclosure | | | | |
| | Datasets generated in | Datasets generated | 51.01 | 50.40 | 36.96 | 46.15 |
| | conventional method | according to present | | | | |
| | | disclosure | | | | |
| | Datasets generated | Datasets generated | 92.96 | 76.00 | 62.69 | 78.06 |
| | according to present | according to present | | | | |
| | disclosure | disclosure | | | | |
| SLIM | Datasets generated in | Datasets generated | 95.88 | 91.48 | 0.06 | 86.85 |
| | conventional method | according to present | | | | |
| | | disclosure | | | | |
| | Datasets generated in | Datasets generated | 92.96 | 64.09 | 0.06 | 74.47 |
| | conventional method | according to present | | | | |
| | | disclosure | | | | |
| | Datasets generated | Datasets generated | 95.72 | 77.33 | 0.10 | 84.44 |
| | according to present | according to present | | | | |
| | disclosure | disclosure | | | | |
| gpt-3.5- | — | Datasets generated in | 77.56 | 33.60 | 23.72 | 45.55 |
| turbo | | conventional method | | | | |
| (ChatGPT) | — | Datasets generated in | 73.23 | 29.96 | 22.76 | 40.98 |
| | | conventional method | | | | |

These models showed reasonable performance when trained and evaluated on datasets generated in a conventional method by supervised learning. On the other hand, these models, when trained on datasets generated in a conventional method and evaluated on datasets generated according to the present disclosure, showed a significant performance drop, with some declining by up to 40%. This outcome suggests that the conventional dataset generation method lacks the complexity required to comprehensively evaluate multi-intent detection abilities.

While replacing the training data with the datasets generated according to the present disclosure does lead to some performance recovery, they are less accurate compared to the datasets generated in a conventional method. This implies that the data generating method according to the present disclosure intrinsically possesses greater complexity.

Additionally, it can be found out that the performance of unsupervised learning is subpar. This indicates that the generative artificial intelligence model has not yet adapted to multi-intent detection tasks.

In step S312, a final dataset is generated by including both multi-intent utterances generated by manual rule-based concatenation and reviewed multi-intent utterances generated by concatenation using a generative artificial intelligence model.

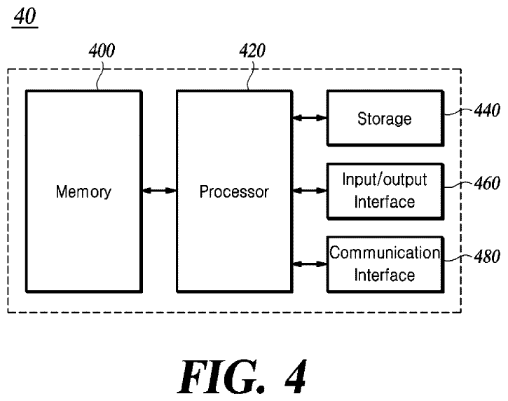

FIG. 4 is a block diagram schematically illustrating a computing device that can be used to implement a method or apparatus according to the present disclosure.

The computing device 40 may include some or all of a memory 400, a processor 420, storage 440, an input/output interface 460, or a communication interface 480. The computing device 40 may structurally and/or functionally include at least some of the data preprocessing module 100, the data selection module 120, the data merging module 140, or the data reviewing module 160. The computing device 40 may be a stationary computing device, such as a desktop computer, a server, an AI accelerator, etc., or may be a portable computing device, such as a laptop computer, a smartphone, etc.

The memory 400 may store a program that allows the processor 420 to perform a method or operation according to various embodiments of the present disclosure. For example, the program may include a plurality of instructions executable by the processor 420, and the method shown in FIG. 3 may be performed when the plurality of instructions are executed by the processor 420.

The memory 400 may be a single memory or multiple memories. In this case, information needed to perform a method or operation according to various embodiments of the present disclosure may be stored in the single memory or stored in the multiple memories in a distributed manner. If the memory 400 includes multiple memories, the multiple memories may be physically separated.

The memory 400 may include at least one of a volatile memory or a non-volatile memory. The volatile memory includes SRAM (static random access memory) or DRAM (dynamic random access memory), and the non-volatile memory includes a flash memory.

The processor 420 may include at least one core for executing at least one instruction. The processor 420 may execute the instructions stored in the memory 400. The processor 420 may be a single processor or a plurality of processors.

The storage 440 retains stored data even if the power supplied to the computing device 40 is cut off. For example, the storage 440 may include a non-volatile memory and/or include a storage medium, such as a magnetic tape, an optical disc, or a magnetic disc.

A program stored in the storage 440 may be loaded onto the memory 400 before executed by the processor 420. The storage 440 may store a file made using a program language, and a program created by a compiler or the like from the file may be loaded onto the memory 400. The storage 440 may store data to be processed by the processor 420 and/or data processed by the processor 420.

The input/output interface 460 may include an input device, such as a keyboard, a mouse, etc., and may include an output device, such as a display device, a printer, etc. The user may trigger execution of a program by the processor 420 via the input/output interface and/or check processing results from the processor 420.

The communication interface 480 may provide access to an external network. For example, the computing device 40 may communicate with other devices (e.g., the data preprocessing module 100, the data selection module 120, the data merging module 140, or the data reviewing module 160) via the communication interface 480.

Each component of the device or method according to the present disclosure may be implemented as hardware or software or may be implemented as a combination of hardware and software. In addition, the function of each component may be implemented as software, and a microprocessor may be implemented to execute the function of the software corresponding to each component.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely a description of the technical idea of one embodiment of the present disclosure. In other words, those having ordinary skill in the art to which one embodiment of the present disclosure belongs may appreciate that various modifications and changes can be made without departing from the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present embodiments is not limited by the illustrations. Accordingly, one of ordinary skill should understand that the scope of the present disclosure should not be limited by the above explicitly described embodiments but by the claims and equivalents thereof.

What is claimed is:

1. A computable-implementable method for generating multi-intent datasets, the method comprising:
collecting single-intent datasets;
preprocessing the collected single-intent datasets while preserving meanings and structures of utterances in the collected single-intent datasets;
selecting a plurality of single-intent utterances to be merged from the preprocessed single-intent datasets; and
merging the plurality of selected single-intent utterances into one multi-intent utterance.

2. The method of claim 1, wherein selecting the plurality of single-intent utterances to be merged includes:
randomly selecting utterances with different intents.

3. The method of claim 1, wherein selecting the plurality of single-intent utterances to be merged includes:
selecting a plurality of single-intent utterances similar in sentence structure or format based on cosine similarity.

4. The method of claim 1, further comprising:
reviewing a multi-intent dataset generated by a generative artificial intelligence model by using a frequency metric, the frequency metric being an evaluation measure configured to determine whether the merging is properly done.

5. The method of claim 2, further comprising:
evaluating the multi-intent dataset by using an artificial intelligence model and generated datasets.

6. The method of claim 1, wherein merging the plurality of selected single-intent utterances into the one multi-intent utterance includes:
merging the plurality of selected single-intent utterances into the one multi-intent utterance by using at least one of ‘;’, ‘or’, ‘before’, ‘after’, ‘additionally’, or ‘finally’.

7. The method of claim 1, wherein merging of the plurality of selected single-intent utterances into the one multi-intent utterance includes:
merging the plurality of selected single-intent utterances into the one multi-intent utterance by removing a conjunction.

8. The method of claim 1, wherein merging the plurality of selected single-intent utterances into the one multi-intent utterance includes:
merging the plurality of selected single-intent utterances into the one multi-intent utterance by transforming a particular utterance into a gerund phrase.

9. The method of claim 1, wherein merging the plurality of selected single-intent utterances into the one multi-intent utterance includes:
merging the plurality of selected single-intent utterances into the one multi-intent utterance by arbitrarily eliminating redundant expressions in multiple sentences.

10. The method of claim 1, wherein merging the plurality of selected single-intent utterances into the one multi-intent utterance includes:
merging the plurality of selected single-intent utterances into the one multi-intent utterance by eliminating redundant expressions in multiple sentences and substituting the redundant expressions with pronouns.

11. An apparatus for generating multi-intent datasets, the apparatus comprising:
a memory configured to store one or more instructions; and
at least one processor configured to execute the one or more instructions stored in the memory,
wherein the at least one processor, by executing the one or more instructions, is configured to:
collect single-intent datasets;
preprocess the collected single-intent datasets while preserving meanings and structures of utterances in the collected single-intent datasets;
select a plurality of single-intent utterances to be merged from the preprocessed single-intent datasets; and
merge the plurality of selected single-intent utterances into one multi-intent utterance.

12. The apparatus of claim 11, wherein when selecting the plurality of single-intent utterances to be merged, the at least one processor is configured to randomly select utterances with different intents.

13. The apparatus of claim 11, wherein when selecting the plurality of single-intent utterances to be merged, the at least one processor is configured to select a plurality of single-intent utterances similar in sentence structure or format based on cosine similarity.

14. The apparatus of claim 11, wherein the at least one processor is configured to:
review a multi-intent dataset generated by a generative artificial intelligence model by using a frequency metric, and
where the frequency metric is an evaluation measure configured to determine whether the merging is properly done.

15. The apparatus of claim 12, wherein the at least one processor is further configured to evaluate the multi-intent dataset by using an artificial intelligence model and generated datasets.

16. The apparatus of claim 11, wherein when merging the plurality of selected single-intent utterances into the one multi-intent utterance, the at least one processor is configured to merge the plurality of selected single-intent utterances into the one multi-intent utterance by using at least one of ‘;’, ‘or’, ‘before’, ‘after’, ‘additionally’, or ‘finally’.

17. The apparatus of claim 11, wherein when merging the plurality of selected single-intent utterances into the one multi-intent utterance, the at least one processor is configured to merge the plurality of selected single-intent utterances into the one multi-intent utterance by removing a conjunction.

18. The apparatus of claim 11, wherein when merging the plurality of selected single-intent utterances into the one multi-intent utterance, the at least one processor is configured to merge the plurality of selected single-intent utterances into the one multi-intent utterance by transforming a particular utterance into a gerund phrase.

19. The apparatus of claim 11, wherein when merging the plurality of selected single-intent utterances into the one multi-intent utterance, the at least one processor is configured to merge the plurality of selected single-intent utterances into the one multi-intent utterance by arbitrarily eliminating redundant expressions in multiple sentences.

20. The apparatus of claim 11, wherein when merging the plurality of selected single-intent utterances into one multi-intent utterance, the at least one processor is configured to merge the plurality of selected single-intent utterances into the one multi-intent utterance by eliminating redundant expressions in multiple sentences and substituting the redundant expressions with pronouns.
